(19) United States
(12) Patent Application Publication
(10) Pub. No.: US 2011/0054826 A1
(43) Pub. Date: Mar. 3, 2011

(54) APPARATUS AND METHOD FOR SIMULTANEOUSLY TESTING WIRELESS COMMUNICATION TERMINALS

(75) Inventors: Jinsoup JOUNG, Seongnam-si (KR); Youngsu KWAK, Suwon-si (KR); Minho YU, Seongnam-si (KR); Jinsam JEONG, Anyang-si (KR)

(73) Assignee: INNOWIRELESS CO., LTD., Seongnam-si (KR)

(21) Appl. No.: 12/874,270

(22) Filed: Sep. 2, 2010

(30) Foreign Application Priority Data
Sep. 3, 2009 (KR) 10-2009-0082893

(51) Int. Cl. G06F 19/00

(52) U.S. Cl. 702/121

(57) ABSTRACT

Disclosed herein is an apparatus and apparatus for simultaneously testing a plurality of wireless communication terminals. The apparatus for simultaneously testing a plurality of wireless communication terminals includes one or more virtual Operating Systems (OSs) each configured to be run under an actual Operating System (OS) and to connect a wireless communication terminal with a test module independently of the actual OS, a plurality of test modules each configured to test a wireless communication terminal under the actual OS or one of the virtual OSs, and a control module configured to assign a plurality of wireless communication terminals recognized by the actual OS to the actual OS and the virtual OSs in a one-to-one correspondence and to assign the plurality of test modules to the actual OS and the virtual OSs in a one-to-one correspondence so that the test modules can be run simultaneously.

### BACKGROUND OF THE INVENTION

1. Field of the Invention

The present invention relates generally to an apparatus and method for testing wireless communication terminals capable of accessing the wireless Internet, and, more particularly, to an apparatus and method for simultaneously testing a plurality of wireless communication terminals.

2. Description of the Related Art

With the development of technology related to wireless communications, not only voice communication but also data communication is rapidly developing. Methods of performing such data communication, that is, methods of wirelessly accessing the Internet, are basically classified into methods of accessing the Internet via a mobile telephone network based on a platform, such as Wireless Application Protocol (WAP) or Wireless Internet Platform for Interoperability (WIPI) and methods of accessing the Internet via a public wireless Local Area Network (LAN) and an access point.

Methods of accessing the Internet via a mobile telephone network have limitations as universal Internet access means due to the screen size, the input interface, and the measured rate-based billing system. Meanwhile, methods of accessing the Internet via a wireless LAN have the limitation that they must be used in an area within a radius of tens of meters around an access point and has the problem of poor mobility.

In order to overcome the problems, Mobile WiMAX capable of making high-speed Internet access at the ADSL-level quality and cost either when at rest or in motion, and WiBro, that is, a Korean mobile WiMax standard, and 3rd Generation Partnership Project (3GPP) Long Term Evolution (LTE), which are subsets of mobile WiMax, have been proposed.

Meanwhile, Mobile WiMAX and 3GPP LTE support a Multiple Input Multiple Output (MIMO) function. MIMO refers to an antenna system capable of multiple input and multiple output. The number of antennas of a base station and the number of antennas of a terminal are both increased to two or more, data is transmitted via multiple paths, and a receiving end detects a signal received via each of the paths, thereby reducing interference and lowering transmission speed.

A wireless communication terminal has power supply limitation and the transmission part of the wireless communication terminal consumes more power than the reception part thereof. Because of this, standards which assume that there are fewer transmitting antennas than receiving antennas have been approved or proposed.

In Mobile WiMAX of IEEE 802.16e, a maximum of two transmitting antennas have been assumed for an upstream link, and three standardization technologies, that is, STTD, spatial multiplexing and collaborative spatial multiplexing, have been adopted.

Meanwhile, in 3GPP Long Term Evolution (LTE), open-loop MIMO is currently being discussed. For the case of two and four antennas, the open-loop MIMO of IEEE 802.16e and the open-loop MIMO of IEEE 802.20 are being discussed in 3GPP LTE. Additionally, in order to achieve spatial diversity, in addition to block code-based space-time (or space-frequency) coding technology, cyclic delay diversity technology is being discussed as a diversity technology which has a more simple implementation. Furthermore, a technique in which space-time (or space-frequency) block coding technology and cyclic delay diversity technology are combined is being discussed together with the above.

FIG. 1 is a block diagram showing the configuration of a conventional apparatus for testing a plurality of wireless communication terminals at the same time.

As shown in FIG. 1, the apparatus for testing a plurality of wireless communication terminals at same time may include a plurality of test devices 20 connected with a plurality of wireless communication terminal 30 in a one-to-one correspondence, and a monitoring device 10 configured to inform a user of the results of testing the wireless communication terminals with the test devices 20.

Each of the test devices 20 includes a test module 23 configured to test a wireless communication terminal under an Operating System (OS), for example, Windows or Linux, and an OS 21 configured to function as an interface between the wireless communication terminal and the test module 23.

Using the above configuration of the apparatus, a user can simultaneously test a plurality of wireless communication terminals, and can be informed of the results of the testing.

Meanwhile, according to the conventional apparatus for simultaneously testing a plurality of wireless communication terminals, a plurality of test devices, that is, a plurality of Personal Computers (PCs), is required to simultaneously test a plurality of wireless communication terminals. Accordingly, the conventional apparatus has the problem of it being very expensive to set up such test devices. Furthermore, since setting up such test devices requires a large amount of space, there is poor space utilization.

Of course, a plurality of terminals can be connected to a single test apparatus and the OS of the corresponding test apparatus can recognize a plurality of wireless communication terminals. However, current Operating Systems (OSs) can recognize a plurality of wireless communication terminals but do not support simultaneous testing. Furthermore, a protocol for performing simultaneous testing has not been discussed.

### SUMMARY OF THE INVENTION

Accordingly, the present invention has been made keeping in mind the above problems occurring in the prior art, and an object of the present invention is to provide an apparatus and method for simultaneously testing a plurality of wireless communication terminals under a single OS.

As is well known, a virtual OS is run under an OS, and functions as an interface between hardware and an application program independently of the OS. Hereinafter an OS is referred to as the “actual OS” to distinguish it from a virtual OS.

In order to accomplish the above object, the present invention provides an apparatus for simultaneously testing a plurality of wireless communication terminals, including one or more virtual OSs each configured to be run under an actual OS, and to connect a wireless communication terminal with a test module independently of the actual OS; a plurality of test modules each configured to test a wireless communication terminal under the actual OS or one of the virtual OSs; and a control module configured to assign a plurality of wireless communication terminals recognized by the actual OS to the actual OS and the virtual OSs in a one-to-one correspondence, and to assign the plurality of test modules to the actual OS and the virtual OSs in a one-to-one correspondence so that the test modules can be run simultaneously.

As described above, the present invention proposes a technology for connecting a plurality of wireless communication terminals with a plurality of test modules in a one-to-one correspondence on a single PC. Accordingly, the object of the present invention which is to simultaneously test a plurality of wireless communication terminals under a single OS can be achieved.

In the above configuration, the control module may be run under the actual OS. The control module may perform functions of collecting test results from the test modules and displaying the collected test results.

In order to accomplish the above object, the present invention provides a method of simultaneously testing a plurality of wireless communication terminals, including step (a) of running one or more virtual OSs each configured to be run under an actual OS and to connect a wireless communication terminal with a test module independently of the actual OS; step (b) of assigning a plurality of wireless communication terminals, recognized by the actual OS, to the actual OS and the virtual OSs in a one-to-one correspondence; step (c) of assigning a plurality of test modules, each configured to test a wireless communication terminal under the actual OS or one of the virtual OSs, to the actual OS and the virtual OSs in a one-to-one correspondence; and step (d) of, after performing steps (b) and (c), simultaneously running the test modules.

The method may be performed under the actual OS.

The method may further include step (e) of displaying test results of the test modules.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing the configuration of a conventional apparatus for simultaneously testing a plurality of wireless communication terminals;

FIGS. 2 and 3 are block diagrams showing the configuration of an apparatus for simultaneously testing a plurality of wireless communication terminals according to an embodiment of the present invention; and

FIG. 4 is a flowchart illustrating a method of simultaneously testing a plurality of wireless communication terminals according to an embodiment of the present invention.

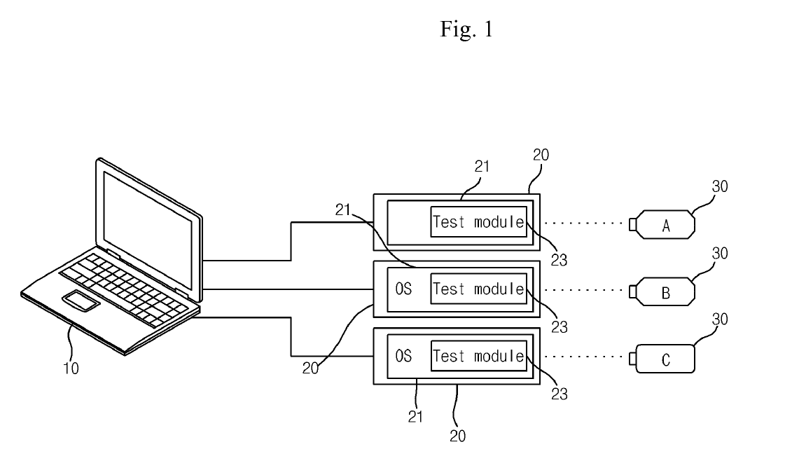

### DESCRIPTION OF THE PREFERRED EMBODIMENTS

Reference now should be made to the drawings, in which the same reference numerals are used throughout the different drawings to designate the same or similar components.

An apparatus and method for simultaneously testing a plurality of wireless communication terminals according to a preferred embodiment of the present invention will be described in detail below with reference to the accompanying drawings.

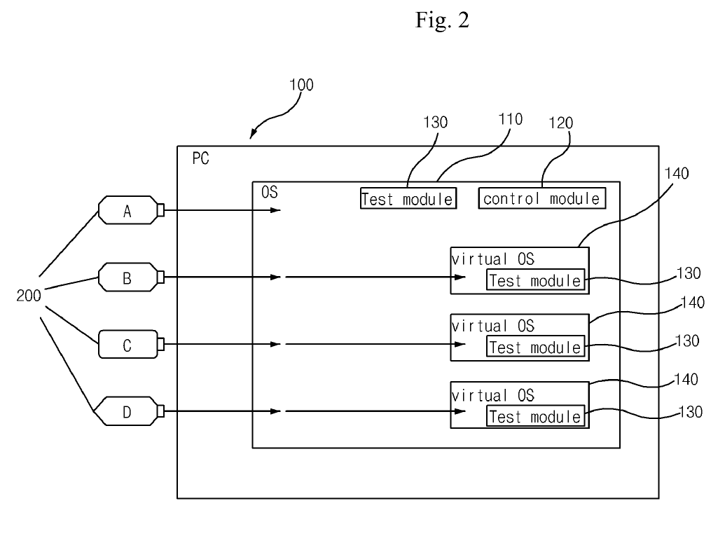

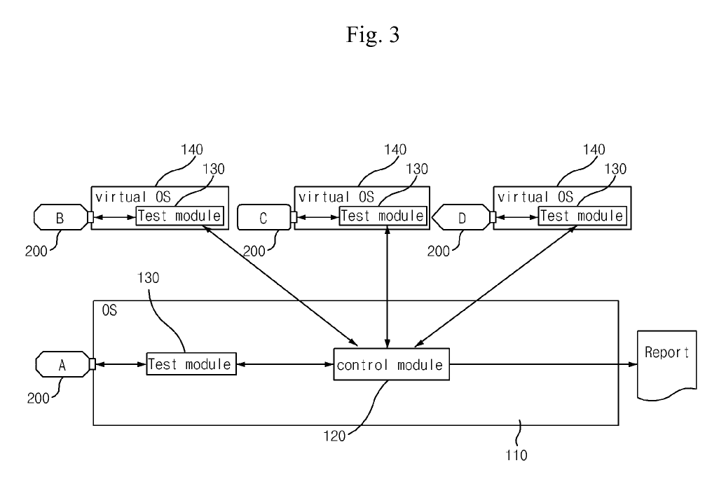

□FIGS. 2 and 3 are block diagrams showing the configuration of an apparatus for simultaneously testing a plurality of wireless communication terminals 100 according to an embodiment of the present invention.

As shown in FIGS. 2 and 3, the apparatus for testing a plurality of wireless communication terminals (hereinafter simply referred to as the “simultaneous test apparatus”) 100 according to the embodiment of the present invention includes an actual OS 110, one or more virtual OSs 140 configured to run under the actual OS 110 and to connect wireless communication terminals to test modules independently of the actual OS 110, a plurality of test modules 130 each configured to test a wireless communication terminal under the actual OS 110 or one of the virtual OSs 140, and a control module 120 configured to assign a plurality of wireless communication terminals 200 recognized by the actual OS 110 to the actual OS 110 and the virtual OSs 140 in a one-to-one correspondence and to assign the plurality of test modules 130 to the actual OS 110 and the virtual OSs 140 in a one-to-one correspondence so that the test modules 130 can be simultaneously run. Using this configuration, a user can test a plurality of wireless communication terminals using a single PC and can be informed of the results of the test, unlike in the conventional technology.

Each of the virtual OSs 140 is run under the actual OS 110 independently of the actual OS 110, and shares the resources of the PC with the actual OS 110 and the other virtual OS(s). The virtual OS 140 may be implemented using Vmware v2.0 which is run under Linux or VMware Workstation which is run under Windows.

Furthermore, the virtual OS 140 may be implemented using VirtualBox which is run under Macintosh. Furthermore, it may be implemented using Virtual PC which is run under Windows.

Since the virtual OS 140 does not influence the actual OS or the other virtual OS(s) even when a fatal error occurs while a plurality of tasks is being performed by it, the virtual OS 140 is good for performing tasks which may cause problems to an OS or tasks which require a plurality of OSs to be run at the same time.

The number of virtual OSs 140 installed in the PC is one less than the number of wireless communication terminals to be tested.

The control module 120 is run under the actual OS 110. In addition to the above-described function, the control module 120 may perform the function of collecting test results which the test modules 130 obtain by testing wireless communication terminals and the function of controlling a video card (not shown) so that the collected test results are displayed.

In detail, each of the test modules 130 communicates with a wireless communication terminal under the actual OS or a virtual OS. The test module 130 receives a test schedule from the control module 120, transmits commands so that the wireless communication terminal can conduct tasks of connecting with and disconnecting from a network and transmitting data in conformity with the test schedule, measures the status of a wireless communication terminal and the parameters of a wireless environment (for example, intensity of a signal received by the terminal, messaged exchanged between the terminal and a base station, etc.), and transmits measured values to the control module 120.

It is appropriate that the specifications of the PC used to implement the simultaneous test apparatus 100 of the present invention include a Core 2 Duo 2.5G or higher-level central processing unit and 4G or more of memory, for example, so as to simultaneously test four wireless communication terminals without hindrance.

The simultaneous test apparatus 100 according to the present invention can be connected to wireless communication terminals 200 via USB ports.

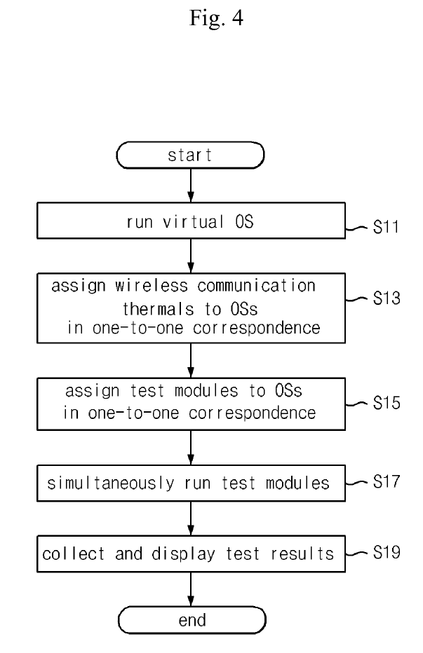

FIG. 4 is a flowchart illustrating a method of simultaneously testing a plurality of wireless communication terminals according to an embodiment of the present invention. It should be noted that the subject of the following description is the control module 120.

First, the virtual OSs 140 are run in response to a user's simultaneous test execution command at step S11.

Thereafter, the plurality of wireless communication terminals 200 recognized by the actual OS 110 are assigned to the actual OS and the virtual OSs 140 in a one-to-one correspondence at step S13.

Thereafter, the plurality of test modules 130 is assigned to the actual OS and the virtual OSs 140 in a one-to-one correspondence at step S15.

Thereafter, the test modules 130 are simultaneously run at step S17. Then each of the test modules 130 tests a corresponding wireless communication terminal in compliance with a predetermined algorithm, and transmits test results to the control module 120.

Thereafter, test results collected from the plurality of test modules 130 are displayed at step S19.

As described above, according to the apparatus and method for simultaneously testing a plurality of wireless communication terminals according to the present invention, a plurality of wireless communication terminals are connected to a plurality of test modules in a one-to-one correspondence using an actual OS and virtual OSs, so that it is possible to simultaneously test a plurality of wireless communication terminals using a single PC. Accordingly, the present invention has the advantage of being able to build a simultaneous test apparatus inexpensively and also the advantage of being able to perform testing simultaneously in a narrow space, compared to the conventional technology.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for simultaneously testing a plurality of wireless communication terminals, comprising:
one or more virtual Operating Systems (OSs) each configured to be run under an actual Operating System (OS), and to connect a wireless communication terminal with a test module independently of the actual OS;
a plurality of test modules each configured to test a wireless communication terminal under the actual OS or one of the virtual OSs; and
a control module configured to assign a plurality of wireless communication terminals recognized by the actual OS to the actual OS and the virtual OSs in a one-to-one correspondence, and to assign the plurality of test modules to the actual OS and the virtual OSs in a one-to-one correspondence so that the test modules can be run simultaneously.

2. The apparatus as set forth in claim 1, wherein the control module is run under the actual OS.

3. The apparatus as set forth in claim 2, wherein the control module collects test results from the test modules, and displays the collected test results.

4. A method of simultaneously testing a plurality of wireless communication terminals, comprising the steps of:
(a) running one or more virtual OSs each configured to be run under an actual OS and to connect a wireless communication terminal with a test module independently of the actual OS;
(b) assigning a plurality of wireless communication terminals, recognized by the actual OS, to the actual OS and the virtual OSs in a one-to-one correspondence;
(c) assigning a plurality of test modules, each configured to test a wireless communication terminal under the actual OS or one of the virtual OSs, to the actual OS and the virtual OSs in a one-to-one correspondence; and
(d) after performing steps (b) and (c), simultaneously running the test modules.

5. The method as set forth in claim 4, wherein the method is performed under the actual OS.

6. The method as set forth in claim 5, further comprising step (e) of displaying test results of the test modules.

7. A computer-readable medium storing a program for executing the method of simultaneously testing a plurality of wireless communication terminals, which is set forth in claim 4.

8. A computer-readable medium storing a program for executing the method of simultaneously testing a plurality of wireless communication terminals, which is set forth in claim 5.

9. A computer-readable medium storing a program for executing the method of simultaneously testing a plurality of wireless communication terminals, which is set forth in claim 6.
